(19) United States
(12) Patent Application Publication
(10) Pub. No.: US 2026/0192807 A1
(43) Pub. Date: Jul. 9, 2026

(54) VEHICLE ASSISTIVE SYSTEM

(71) Applicant: IRIDER, Le Mans (FR)

(72) Inventors: Frédéric Delahais, Clamart (FR); Jean-François Simon, Arnage (FR); Thomas Rayer, La Flèche (FR); Jan De Moortel, Kortrijk (BE)

(21) Appl. No.: 19/291,994

(22) Filed: Aug. 6, 2025

Related U.S. Application Data
(63) Continuation of application No. 17/925,978, filed on May 20, 2021, now abandoned.
(60) Provisional application No. 63/027,654, filed on May 20, 2020.

(51) Int. Cl. B60W 50/00; B60W 10/04; B60W 10/18; B60W 30/095; B60W 50/14; B60W 50/16

(52) U.S. Cl. CPC B60W 50/0097; B60W 10/04; B60W 10/18; B60W 30/0953; B60W 30/0956; B60W 50/16; B60W 2050/143; B60W 2050/146; B60W 2510/0623; B60W 2510/0676; B60W 2520/06; B60W 2520/10; B60W 2530/209; B60W 2554/4041; B60W 2554/4042; B60W 2554/4044; B60W 2554/802; B60W 2555/20; B60W 2556/10; B60W 2710/18; B60W 2720/106

(57) ABSTRACT

A vehicle assistive system includes a plurality of context information generating devices, each configured to output context information relating to a mobile vehicle, a processor, and a non-transitory computer-readable medium comprising instructions for performing acts. The acts include: generating one or more object representations based on corresponding context information; predicting one or more future states, each relating to a state of the object representation at a future time; eliminating the future states having a probability that does not meet a corresponding threshold; detecting a future event for one or more of the future states; providing one or more action items for each detected future event; performing one or more actions associated with the action items including an action selected from the group consisting of generating a notification using a notification device, and controlling the mobile vehicle using a control device.

### CROSS-REFERENCE TO RELATED APPLICATION

This Application is a Continuation of U.S. application Ser. No. 17/925,978, filed Nov. 17, 2022, which is a Section 371 National Stage Application of International Application No. PCT/IB2021/054388, filed on May 20, 2021, which is based on and claims the benefit of U.S. provisional patent application Ser. No. 63/027,654, filed on May 20, 2020, which is incorporated by reference and published as WO 2021/234632 A1 on Nov. 25, 2021, in English the contents of which are hereby incorporated by reference in their entireties.

### FIELD

The present disclosure relates to a vehicle assistive system that provides real-time, actionable insights in response to events using predictive probabilistic situational analysis.

### BACKGROUND

Vehicle assistive systems are systems that provide an assistive function to the operator of the vehicle, such as lane-keeping assistance, emergency braking and other assistive functions. Conventional vehicle assistive systems typically use procedural functions to perform multiple synchronous or asynchronous tasks within a delimited field of action. These systems limit their analysis to the presently encountered conditions, such as an imminent collision. Thus, conventional vehicle assistive systems do not anticipate future situations or events, possibly involving a plurality of actors under rapidly varying conditions.

### SUMMARY

Embodiments of the present disclosure include a vehicle assistive system for a mobile vehicle and methods performed by the system. One embodiment of the vehicle assistive system includes a plurality of context information generating devices, each of which is configured to output context information relating to the mobile vehicle. The system also includes a processor, and a non-transitory computer-readable medium including instructions stored thereon, which when executed by the processor configure the vehicle assistive system to perform acts. The acts include: generating one or more object representations based on corresponding context information including a mobile vehicle object representation relating to parameters of the mobile vehicle; predicting one or more future states for each object representation, each future state relating to a state of the object representation at a future time; eliminating the future states of each object representation having a probability that does not meet a corresponding threshold; detecting a future event for one or more of the future states; providing one or more action items for each detected future event; performing one or more actions associated with the action items including an action selected from the group consisting of generating a notification using a notification device, and controlling the mobile vehicle using a control device.

One embodiment of the method performed by a vehicle assistive system of a mobile vehicle includes: receiving context information relating to travel of the mobile vehicle from a plurality of context information generating devices; generating one or more object representations based on corresponding context information including a mobile vehicle object representation relating to parameters of the mobile vehicle; predicting one or more future states for each object representation, each future state relating to a state of the object representation at a future time; eliminating the future states of each object representation having a probability that does not meet a corresponding threshold; detecting a future event for one or more of the future states; providing one or more action items for each detected future event; and performing one or more actions associated with the action items including an action selected from the group consisting of generating a notification using a notification device, and controlling the mobile vehicle using a control device.

In one embodiment of the system and method generating one or more object representations includes generating the mobile vehicle object representation based on mobile vehicle context information selected from the group consisting of a location of the mobile vehicle, a speed of the mobile vehicle, a direction of travel of the mobile vehicle, driver behavior information, weather condition information, travel condition information, a rate of fuel consumption, a remaining fuel capacity, a driving range of the mobile vehicle, and a temperature of the engine.

In one embodiment, the context information generating devices include: a GPS unit providing at least one of the location, speed, and direction of the mobile vehicle; a weather receiver configured to output the weather condition information including at least one of a temperature, wind speed, and wind direction; a travel conditions receiver configured to output the travel condition information including at least one of traffic conditions and road conditions; a fuel gauge; and/or a temperature sensor.

In one embodiment, generating the one or more object representations includes generating a physical object representation relating to a physical object in a vicinity of the mobile vehicle based on physical object context information selected from the group consisting of a location of the physical object, a speed of the physical object, and a travel direction of the physical object.

Embodiments of the context information generating devices also include a perception device configured to detect at least one of the location of the physical object, the speed of the physical object, and the travel direction of the physical object. Examples of the perception device include one or more cameras, a radar device, and a lidar device.

The one or more physical objects may include a motor vehicle, a pedestrian, infrastructure, and/or a cellular vehicle-to-everything (C-V2X) participant.

In one embodiment, predicting one or more future states includes predicting future travel states of the mobile vehicle object representation and the physical object representation, detecting the future event includes detecting a future collision event between the mobile vehicle and the physical object based on the future travel states and a preset separation distance, and performing the one or more actions includes at least one of generating a collision notification using the notification device, and accelerating or decelerating the mobile vehicle using the control device.

In one embodiment, predicting one or more future states includes predicting future fuel states of the mobile vehicle based on at least one of the speed of the mobile vehicle, the weather condition information, historical ride information, the rate of fuel consumption, the remaining fuel capacity, and the driving range of the mobile vehicle; detecting the future event includes detecting a future fuel event based on the future fuel states and preset fuel-related limits; and performing the one or more actions includes at least one of generating a fuel notification using the notification device, and decelerating the mobile vehicle using the control device.

In one embodiment, predicting one or more future states includes predicting engine temperature states of an engine of the mobile vehicle based on at least one of the speed of the mobile vehicle, the weather condition information, and the temperature of the engine; detecting the future event includes detecting a future engine temperature event based on the future engine temperature states, and preset engine temperature thresholds and limits; and performing the one or more actions includes generating an engine temperature notification using the notification device.

In one embodiment, the mobile vehicle includes one or more control devices selected from the group consisting of a brake for slowing the mobile vehicle and a throttle for accelerating the mobile vehicle; and performing one or more actions includes one of decelerating the mobile vehicle using the brake, and accelerating the mobile vehicle using the throttle.

In one embodiment, the mobile vehicle includes one or more notification devices selected from the group consisting of a display screen, a head-up display, a sound device, a haptic device, and indicating lights; and performing one or more actions includes generating a notification using one or more of the notification devices.

In one embodiment, detecting a future event for one or more of the future states includes: detecting a plurality of future events for the one or more future states; the acts include providing a severity level for each detected future event; and performing one or more actions associated with the action items includes ranking the detected future events based on their corresponding severity levels, and performing one or more actions corresponding to the one or more action items of the detected future event having the highest severity level.

In some embodiments, the mobile vehicle is in the form of a two-wheeled mobile vehicle, such as a motorcycle or an E-bike.

Human reactivity to an event is greatly improved when the event is anticipated. The reaction is both faster and more appropriate as the anticipation of an event typically causes the consideration of possible courses of action to be taken.

Embodiments of the present disclosure relate to a vehicle assistive system of a mobile vehicle that predicts future situations involving the mobile vehicle and monitors the evolution of the present situation towards any of the predicted situations. This allows the system to anticipate events involving the vehicle, such as collision events, and provide early notification and/or vehicle control action to such events. As a result, the vehicle assistive system of the present disclosure increases the likelihood of avoiding collisions and other events over conventional systems.

An exemplary embodiment not only monitors the present situation as represented by the currently available data, but also predicts future situations that have a probability of occurring given the current environment, and monitors the evolution of the present situation towards any of these predicted situations in order to proactively report a dangerous situation.

Such predictions result in a temporal model of possible situations based on past, present and predicted states. The temporal model is continuously updated to accurately reflect the evolution of the environment.

Continuous evaluation of this temporal model permits the assistive system to assess the probability of such situations occurring in the future and the associated danger levels.

If the probability of one or more situations exceeds a threshold, the associated danger levels are prioritized and appropriate notification and/or control messages are dispatched.

The use of one or more embodiments of this disclosure may result in a smarter and more proactive assistive system, which benefits the overall safety and well-being of the user of the mobile vehicle, such as a user of a two-wheeled vehicle.

To build up such a temporal model, the proposed assistive system constructs a context to represent the environment, also referred to as the ‘world view’, in which the assistive system operates. The context contains physical actors like the mobile vehicle itself, the rider, other cars, pedestrians, the road infrastructure, and/or other physical actors. The context may also contain more abstract actors like weather. Thus, any actor, physical or abstract, that can potentially have an impact within the scope of the assistive system can be represented in the context.

The context evolves over time, reflecting the changes in the environment, as some actors may have changed behavior, others may no longer play a relevant role, and new actors are added.

In order to be effective, central access to all contextual data is an essential requirement. Here, current systems also fall short, as data is typically silo-ed making it impossible to get a complete view of the context or having to take additional steps that introduce additional latency.

A state represents the actual or predicted state of the context at a certain point in time. Multiple states can exist at the same point in time, representing different possible futures that can evolve from the present state.

Each relevant actor in the environment is represented in the context as an object or object representation with properties and behavior. All these properties are classified and available to be used in an exemplary embodiment of the current disclosure.

Each object is capable of predicting future states at different times t, including a probability that such a future state will occur. Each object maintains a list of the future states it generates. States that can no longer materialize, i.e., have zero probability or probability below a set threshold, are removed from the list.

Each change in a property of the object triggers the evaluation and generation of states. For example, a vehicle object can predict future states of the vehicle with the future position, speed and direction of the vehicle based on its current position, speed and direction.

Some vehicle objects can predict a future state where the fuel of the vehicle (e.g., gas, battery, etc.) needs replenishing (e.g., refueling, recharging, etc.) given the current driving behavior.

Accordingly, objects may have a multitude of state prediction functions. Such a function has access to the internal object data like its current state and historic values, but also has access to all data from the objects present in the context.

A state prediction function can be any function from a simple procedural algorithm to an advanced machine-learning model trained on a relevant data set that returns a predicted value and probability. For example, an advanced model can predict lane-changing behavior in a traffic jam. The model may take as input factors such as time of day, traffic density, weather conditions, etc.

An event descriptor is an object that describes an event and holds one or more of the following:
a type,
a severity level or level of criticality,
at least one actionable insight or item, but possibly multiple actionable insights to support different notification types,
a set of applicable object's type,
an event detection function that evaluates a given state for an event of this type and returns an event object if true,
event specific data like, e.g., thresholds and limits provided by the equipment manufacturer.

The system maintains a store containing a list of event descriptors relevant to the scope of the assistive system. This store (e.g., computer-readable medium) can be dynamically updated with new or improved descriptors.

In an exemplary embodiment of the current disclosure, the store would contain event descriptors relevant to a mobile vehicle such as a collision warning, a critical collision warning, a lane change warning, a low battery warning, an adverse weather event, etc.

The plurality of predictions generated by the objects in the context generates future states of the context at different times t. For each future state of every object, and for each event descriptor in the store, the event detection function of the descriptor creates event representations for occurring events and stores these events in the state.

Future states that have no events are discarded to reduce the burden on data processing storage resources of the system.

The vehicle assistive system performs a future state probability evaluation to track the evolution of the probability of occurrence of every future state in every object. When the probability that a future state occurs exceeds a threshold, such as that set by the generating object, all events associated with the future state are returned to the assistive system with their actionable insights or items.

In some embodiments, a severity level is also returned to the assistive system along with the actionable insights or items. In case thresholds of multiple states have been exceeded, the actionable insights or items of all states are returned ordered by the corresponding severity level.

Threshold values can be constant, but can also be a function of the features of the generating object and/or features of other objects in the context.

An actionable insight or item represents a message that will be sent to the notification system indicating the issue or event, and/or a control action that controls the mobile vehicle using a control device of the mobile vehicle (e.g., brake or throttle).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of a vehicle assistive system of a mobile vehicle, in accordance with embodiments of the present disclosure.

FIG. 2 is a simplified diagram of aspects of the vehicle assistive system, in accordance with embodiments of the present disclosure.

FIG. 3 is a simplified block diagram of an object representation, in accordance with embodiments of the present disclosure.

FIG. 4 is a simplified block diagram of an event descriptor, in accordance with embodiments of the present disclosure.

FIG. 5 is a flow chart of an example of a method performed by a vehicle assistive system, in accordance with embodiments of the present disclosure.

FIGS. 6A and 6B are simplified diagrams illustrating examples of collision-related events, in accordance with embodiments of the present disclosure.

FIG. 7 is a simplified diagram illustrating an example of fuel-related events, in accordance with embodiments of the present disclosure.

FIG. 8 is a simplified diagram illustrating an example of an engine malfunction related event, in accordance with embodiments of the present disclosure.

FIG. 9 is a simplified block diagram of an example of a computing architecture of the vehicle assistive system, in accordance with embodiments of the present disclosure.

FIG. 10 is a simplified block diagram illustrating an example of a computing system, in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

Specific details are given in the following description to provide a thorough understanding of the embodiments. However, it is understood by those of ordinary skill in the art that the embodiments may be practiced without these specific details. For example, conventional circuits, systems, networks, processes, frames, supports, connectors, motors, processors, and other components may not be shown, or shown in block diagram form in order to not obscure the embodiments in unnecessary detail.

As will further be appreciated by one of skill in the art, embodiments of the present disclosure may be embodied as methods, systems, devices, and/or computer program products, for example. The computer program or software aspect of embodiments of the present disclosure may comprise computer readable instructions or code stored in a non-transitory computer readable medium or memory. Execution of the program instructions by one or more processors (e.g., central processing unit, microprocessor, microcontroller, etc.) results in the one or more processors performing one or more functions or method steps described herein. Any suitable patent subject matter eligible computer readable media or memory may be utilized including, for example, hard disks, CD-ROMs, optical storage devices, magnetic storage devices, etc.

Embodiments of the present disclosure relate to a vehicle assistive system that provides real-time, actionable insights in response to events using predictive probabilistic situational analysis. Unlike conventional vehicle assistive systems that focus only on reacting to presently encountered conditions, embodiments of the present disclosure operate to anticipate future conditions of not only the mobile vehicle being serviced, but also external actors and factors that may play a role in potential future events or situations encountered by the vehicle, such as a collision event (e.g., collision with another vehicle, pedestrian or object), a fuel event (e.g., low fuel condition), an engine malfunction event (e.g., overheated engine), a weather condition event, and/or other events.

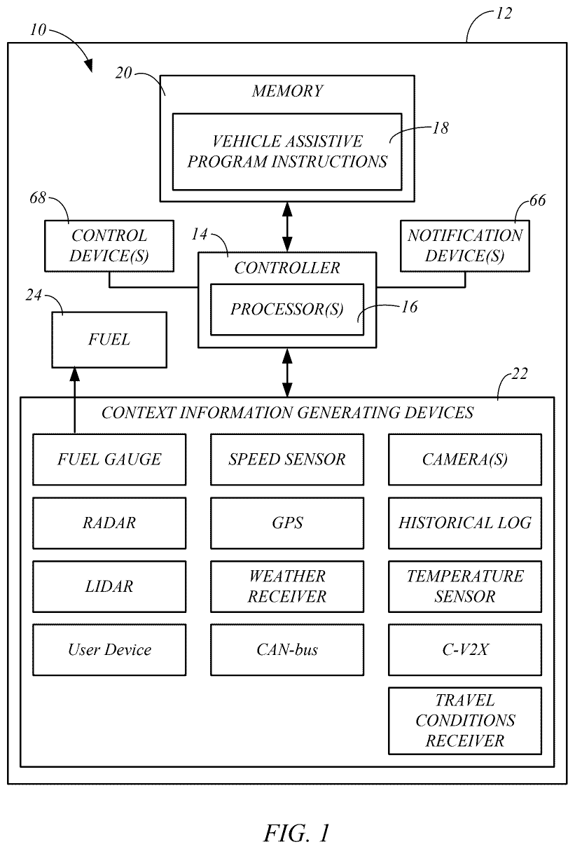

FIG. 1 is a simplified diagram of a vehicle assistive system 10 of a mobile vehicle 12, in accordance with embodiments of the present disclosure. The system 10 includes a controller 14 having at least one processor 16 and program instructions 18 contained in non-transitory computer readable media or memory 20.

The mobile vehicle 12, in which the system 10 is implemented, is a physical, real-world vehicle and may take on any suitable form. In some embodiments, the mobile vehicle 12 is an automobile, a two-wheeled vehicle (e.g., a motorcycle, an electric bicycle), a boat or watercraft (e.g., personal watercraft), an electric vehicle that does not require a driver's license or permit to operate (e.g., a golf cart, a scooter, a personal electric vehicle), an airplane, or another mobile vehicle. While embodiments of the system 10 are applicable to all of these vehicles, two-wheeled vehicles may be the most vulnerable participants in today's mobility environment, and may gain the most benefit of the vehicle assistive system 10. In addition to the features shown in FIG. 1, conventional two-wheeled vehicles generally includes a frame, first and second wheels, and a propulsion system such as an engine or motor.

Features of the system 10 may be used to improve the safety and well-being of two-wheeled and other vehicles 12 by anticipating potentially harmful events or situations and reporting actionable information in a timely manner so the rider can react to avoid getting in harm's way. A typical example of such a potentially harmful event or situation is a collision with another vehicle. However, the system 10 may also be used to report less extreme events, such as imminent engine failure, an upcoming dangerous crossing or changing weather conditions, for example. Additionally, embodiments of the system 10 may provide supportive messages that can help alleviate driver concerns, such as finding a refueling or recharging station in time, or improving performance like suggesting a change in driving behavior to reduce fuel consumption, for example.

The system 10 includes a plurality of context information generating devices, generally referred to as 22, each of which is configured to collect or detect context information relating to the relevant context representing the environment of the vehicle 12, and output the context information. Examples of the context information generating devices 22 include devices that collect or detect context information in the form of parameters of the mobile vehicle 12, such as a speed sensor of the vehicle 12 that outputs a speed at which the vehicle 12 is traveling; a global positioning system (GPS) device or unit that may output a position of the vehicle 12, a speed at which the vehicle 12 is traveling, and a direction in which the vehicle 12 is traveling; a CAN-bus that provides vehicle parameters, such as the speed at which the vehicle 12 is traveling, engine temperature, and other vehicle parameters; a temperature sensor that outputs a temperature of the mobile vehicle 12, such as the temperature of the engine of the mobile vehicle 12; and/or a fuel gauge configured to output a current and/or remaining level of the fuel 24 of the vehicle, for example. In FIG. 1, the fuel 24 may represent a combustible fuel, such as gasoline, or an electrical charge of a battery for an electric mobile vehicle, for example.

Other context information generating devices 22 of the system 10 generally relate to detecting or collecting context information in the form of parameters of physical objects or actors in the environment of the mobile vehicle 12, such as infrastructure (road signs, guardrails, medians, roads, intersections, etc.), pedestrians, mobile vehicles, and/or other physical objects. Such context information generating devices 22 generally include one or more perception devices or systems that are configured to detect and output the type, location, speed, direction of travel, and/or other information of physical objects or actors outside the mobile vehicle 12. Such perception devices or systems may include one or more cameras (e.g., front-facing camera and/or rear-facing camera) that may capture images of objects outside the vehicle 12 and output information relating to captured physical objects, such as an object type, a location of the object, a speed of the object relative to the vehicle, a direction the object is traveling, etc.; a radar device configured to detect and/or track a physical object and output an object type, a location of the object, a speed and/or direction of movement of the physical object relative to the motor vehicle 12; a lidar (light detection and ranging) device that operates similar to the radar device; and/or other perceptive devices or systems, for example.

Another type of context information generating device 22 that may detect or collect context information relating to other vehicles includes a cellular vehicle-to-everything (C-V2X) device or similar device that provides real-time structured information about other vehicles, pedestrians, infrastructure or any C-V2X enabled participant in the vicinity of the mobile vehicle 12.

Additional context information generating devices 22 include devices for collecting and outputting more abstract information that may affect the future states of the mobile vehicle 12 and other actors. Such devices 22 may include, for example, a weather receiver that is configured to obtain and output weather condition information regarding the environment of the vehicle, such as a temperature, wind speed, wind direction, and/or other weather condition information. The context information generating devices 22 may also include a travel conditions receiver that is configured to output context information relating to the travel conditions in the environment of the mobile vehicle, such as traffic conditions, traffic density, road closures, road works, road maps, and/or other travel condition information. The weather condition information and the travel condition information may be received from cloud-based services, or from another suitable source.

The context information generating devices 22 may include one or more user devices, such as a smartphone, a smartwatch and/or bracelet that provides context information such as health information (e.g., heart rate, blood pressure, etc.) of the user.

Additionally, the context information generating devices 22 may include devices that provide information, such as operator driving behavior or tendencies and other information that may be maintained in a historical log.

The devices 22 may communicate their context information using any suitable communication technique, such as through a wired or wireless data communication (e.g., Wi-Fi, cellular communications, Bluetooth, etc.). Such communications may be facilitated by conventional communications circuitry represented by the controller 14, for example.

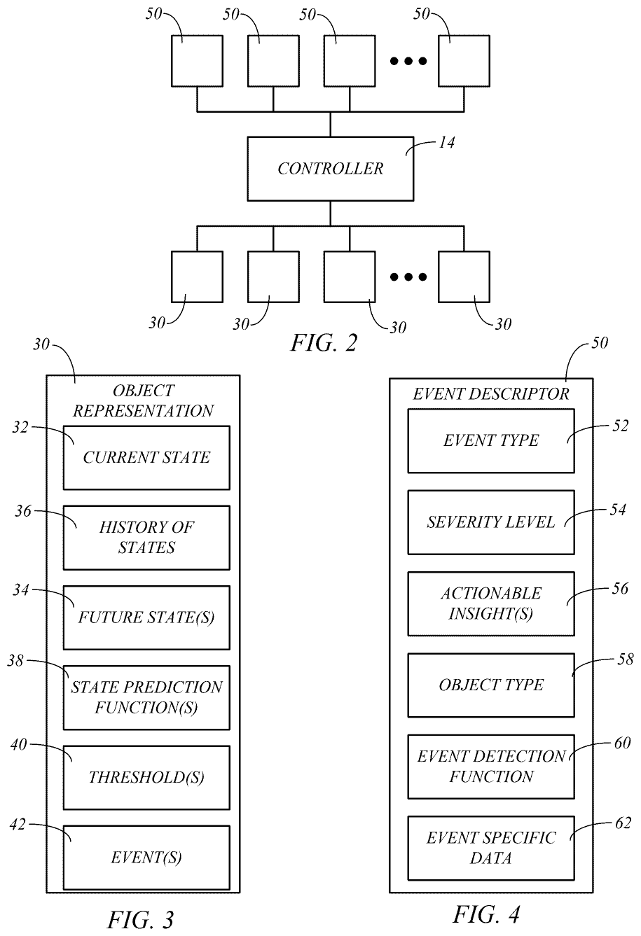

The context information generated by the devices 22 is used by the system 10 to generate object representations 30 of various relevant actors based on the context of the environment in which the mobile vehicle 12 operates, as generally illustrated in the simplified diagram of FIG. 2. The object representations 30 are attributed with properties and behaviors that form a temporal model of the environment that is used by the system 10 to anticipate future states of the actors and predict events between the mobile vehicle 12 and the actors.

Each of the object representations 30 may include a current state 32 of the represented object, one or more future states 34 of the represented object at a future time, a history of the states 36 of the represented object, one or more state prediction functions 38, one or more thresholds 40, one or more events 42 that involve the represented object, and/or other information, as indicated in the example of components of an object representation 30 provided in the block diagram of FIG. 3.

The current state 32 of the object representation 30 relates to its most recent state. Each of the object representations 30 periodically update its current state 32 over time, such as on a real-time or near real-time basis, on a time schedule triggered by the location of the mobile vehicle 12, or based on the availability of new information. The frequency of the updates may be dependent on the type of context information generating device or devices 22 that are being used.

The prior states of the object representation 30 may be maintained in the history of states 36. The previous states contained in the history of states 36 may be used to predict future states 34 for the represented object 30, for example.

Each future state 34 relates to a state of the represented object 30 at a future time and may be based on the current state 32 of the object representation, previous states of the object representation provided in the history 36, current and future states of other object representations 30, and/or other factors that may influence the future state 34 of the represented object 30. For example, a vehicle object representation 30 may predict future states of the vehicle 12 with the future position, speed and direction of the vehicle 12 based on its current state, such as its current position, speed and direction.

The future states 34 may be generated by the one or more state prediction functions 38 each time the current state 32 changes. The state prediction functions 38 have access to the internal object data like the current state 32 and the historic states 36, and can also access all of the data from the object representations 30 present in the context, for determining the future states 34.

Each state prediction function 38 can be any function from a simple procedural algorithm to an advanced machine-learning model trained on a relevant data set that returns a predicted value and probability. For example, an advanced model can predict lane-changing behavior in a traffic jam. The model may take as input factors such as time of day, traffic density, weather conditions, etc.

The probability of a given future state 34 may be determined by the thresholds 40. Future states 34 that can no longer materialize or do not meet the corresponding threshold 40, are removed from the list of future states 34. This filtering step allows for more efficient use of the processing resources of the system 10.

The one or more events 42 relate to predicted or detected events of the future states 34. When the object representation includes future states having associated events 42, the system 10 may perform an action that is determined by the event, such as issuing a notification or controlling the mobile vehicle 12.

Some examples of object representations 30 include mobile vehicle object representations, physical object representations, and weather object representations. Other object representations 30 may be generated to model other actors of a given environment using similar techniques to those described herein.

The mobile vehicle object representations may each model a state of an aspect or parameter of the mobile vehicle 12, from which future states of the aspect or parameter may be predicted. For example, the mobile vehicle object representations may model a travel state of the mobile vehicle 12, a temperature state of the mobile vehicle 12, a fuel state of the mobile vehicle 12, and/or another aspect or parameter of the mobile vehicle 12.

The travel state for the mobile vehicle object representation may model a position, speed and direction at which the mobile vehicle 12 is traveling, based on data from the GPS unit 22, for example. As used herein, the term “travel” or “traveling” includes situations where the speed of the mobile vehicle 12 is zero. Additionally, the speed and direction of travel may be relative to the ground or another object. For this mobile vehicle object representation, the future states may include predicted location, speed and direction of travel of the mobile vehicle 12 at a future time, which may be based on the current travel state, previous travel states, road condition information, current and/or future states of other object representations (e.g., other vehicles) modeled by other object representations, weather conditions, and/or other factors.

The temperature state may model the temperature of the engine of the mobile vehicle 12 based on the context information from one or more of the corresponding devices (e.g., temperature sensor), and may be monitored by the system 10 to predict when an engine failure may occur due to overheating, for example. Future temperature states may be predicted based on, for example, the current temperature state, previous temperature states, current and/or future states of other object representations, road condition information, travel information, weather conditions, driving tendencies of the operator of the mobile vehicle provided by the historical log, and/or other factors.

The fuel state may model the fuel consumption or travel range of the mobile vehicle, based on the context information from the fuel gauge 22, for example. Future fuel states may be predicted based on the current fuel state, previous fuel states, current and/or future states of other object representations, driving tendencies, road condition information, travel information, weather conditions, and/or other factors.

Physical object representations may model states of physical objects that are outside the mobile vehicle 12 and may play a role in an event with the mobile vehicle 12. The physical objects may include, for example, other vehicles, pedestrians, infrastructures (road signs, guardrails, medians, roads, intersections, etc.), and/or other physical objects. The modeled states of physical objects may include a travel state of the physical object that is based on information received from a suitable perception system or device 22, such as the one or more cameras, the radar device, the lidar device, or other suitable context information generating devices 22. Here, the travel state of a modeled physical object may include the position, speed and direction of travel of the physical object relative to the mobile vehicle 12. Alternatively, the travel state of a physical object may be based on context information received from a C-V2X device 22, in which case the travel state may include the position, speed and direction of travel relative to the ground, for example. Future travel states for the physical object may be based on the current travel state, previous travel states of the physical object, current and/or future states of other object representations, road condition information, travel condition information, weather conditions, and/or other information.

Weather object representations may model various states of aspects or parameters of the weather within the vicinity of the mobile vehicle 12, based on weather information received from the weather receiver 22, for example. The states may include a temperature state, a wind speed and direction state, and other states. Future states may be predicted using the current state, previous states, current and/or future states of other object representations, time of day, and/or other information.

In some embodiments, the system, such as the processors 16 of the controller 14, utilize event descriptors 50 to detect a future event or situation of the future states 34 of the object representations 30, as indicated in FIG. 2. Each event descriptor 50 is an object that describes an event and may include one or more of the items illustrated in the example event descriptor 50 of FIG. 4, such as a type 52, a severity level or level of criticality 54, one or more actionable insights or action items 56, a set of applicable object types 58, one or more event detection functions 60, and event specific data 62.

The type 52 refers to a type of event, such as a collision event, an engine failure event, a lane change event, a low fuel event, an adverse weather event, or other event.

The severity level or level of criticality 54, relates to the seriousness of the event. The severity level 54 may be used to rank the event relative to other detected events when multiple events are detected, which allows the system 10 to address the most severe events first, followed by the events that are less severe.

The actionable insights or action items 56 define actions that are to be performed by the system 10 in response to the detected event. These may include the generation of one or more notifications using a notification device 66 (FIG. 1), and/or controlling the mobile vehicle 12 using a control device 68 (FIG. 1). Examples of the notification device 66 include a display screen, a head-up display, a sound device, a haptic device, indicating lights, and/or other suitable notification devices. Examples of the control device 68 include a brake for decelerating the mobile vehicle and a throttle for accelerating the mobile vehicle.

The set of applicable object types 58 refers to the types of object representations 30 to which the event descriptor 50 pertains. Thus, the set of applicable object types 58 allows the system 10 to filter the event descriptors 50 that are applied to a given future state 34 of an object representation 30. For example, an event descriptor 50 having the event type 52 of a collision event, may have applicable object types of the mobile vehicle object representation for the travel state of the mobile vehicle 12, or the physical object representation for the travel state of a physical object, etc. As a result, the set of applicable object types 58 allows for more efficient use of the processing resources of the system 10 by applying each event descriptor 50 to a subset of the object representations 30, rather than to all of the object representations 30.

The event detection function 60 evaluates the future states 34, such as those relating to the object type 58, for an event of the event type 52, and outputs one or more event objects or representations 42 when there is a match for storage by the object representation 30 in association with the corresponding future state 34.

Parameters that define aspects of the event may be set by the event specific data 62, which may include thresholds and limits. When the event relates to equipment, the event specific data 62 may define the thresholds and limits assigned by the equipment manufacturer. For example, an engine may have a temperature limit for proper operation, which may be used as a threshold for triggering a malfunction event of relating to an object representation of the engine.

Thus, the event detection function 60 compares parameters of the event to the future states 34 and, when a match exists, the event 42 is generated for the future state 34. The generated event objects or representations 42 are stored in association with the future state 34 of the corresponding object representation 30.

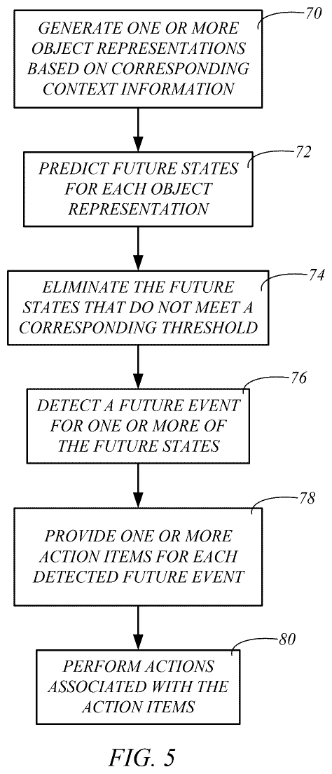

FIG. 5 is a flowchart illustrating a method implemented by the system 10, such as in response to the execution of the program instructions 18 stored in the memory 20 by the one or more processors 16 of the controller 14, for example. At 70 of the method, one or more object representations 30 (FIG. 2) are generated based on corresponding context information generated by one or more of the context information generating devices 22, and other sources. In one embodiment, the one or more object representations 30 generated at 70 of the method include one or more mobile vehicle object representations described herein.

At 72 of the method, one or more future states 34 for each of the object representations 30 are predicted, such as by the one or more state prediction functions 38 of the object representations 30. Each future state 34 relates to a state of the object representation 30 at a future time and may be based on the current state 32 of the object representation, previous states 36 of the object representation, current states 32 and future states 34 of other object representations 30 (e.g., other vehicle object representations, physical object representations, weather object representations, etc.), and/or other factors that may influence the future state 34 of the object representation 30, as discussed above. For example, a future position or travel state for the mobile vehicle object representation may be an estimate of the position, speed and direction of travel of the mobile vehicle 12 at a future time based on the current position or travel state, previous position or travel states, weather condition information, road condition information, and/or other relevant information.

At 74 of the method, future states 34 that do not meet a probability threshold 40 (FIG. 3) of the object representation 30 are eliminated. Thus, a probability of the future state, which may be determined by the state prediction functions 38, is determined for each of the future states 34 and compared to a corresponding threshold 40 of the object representation 30. The future states 34 whose probabilities do not meet the threshold requirement are eliminated from the list contained in the object representation 30.

At 76 of the method, a future event or situation 42 is detected for one or more of the future states 34 of each object representation 30. As discussed above, these events are detected using the event detection function 60 of the corresponding descriptor 50. When an event is detected for a future state 34, the event 42 is stored in the object representation 30 in association with the future state 34.

At 78 of the method, the one or more actionable insights or action items 56 are provided for each detected future event. In some embodiments, the detected events including the action items 56 are stored as events 42 (FIG. 3) in the corresponding object representation 30.

In some embodiments of step 78, the severity levels 54 corresponding to each detected future event are provided along with corresponding action items. The severity levels 54 may be used to rank the order in which the action items of the detected events are processed.

At 80 of the method, the system 10, such as the controller 14, performs one or more actions that are associated with the action items 56 of the detected event. When multiple events are detected, the one or more actions associated with the action items 56 of the event having the highest severity level 54 are performed first by the system 10 in step 80. In some embodiments, the action items include providing a notification using the notification device 66, and/or controlling the mobile vehicle 12 using the control device 68.

The notification may comprise an audible alarm using an audible device (e.g., speaker), a visible alarm using indicating lights, a message on a display screen or head-up display, a physical alarm through a haptic device (e.g., vibrating steering wheel), and/or another suitable notification using the notification device 66.

The controlling action of the mobile vehicle 12 may involve decelerating the mobile vehicle 12 using a brake, accelerating the mobile vehicle 12 using a throttle, and/or performing another suitable control of the mobile vehicle 12 using the control device 68.

Some embodiments of the generating step 70 involve generating the mobile vehicle object representation based on mobile vehicle context information generated by the devices 22, such as a location of the mobile vehicle, a speed of the mobile vehicle, a direction of travel of the mobile vehicle, driver behavior information, weather condition information, travel condition information, a rate of fuel consumption, a remaining fuel capacity, a driving range of the mobile vehicle, and/or a temperature of the engine. This context information may be generated using, for example, the GPS unit providing at least one of the location, speed, and direction of the mobile vehicle, the weather receiver configured to output the weather condition information including at least one of a temperature, wind speed, and wind direction, the travel conditions receiver configured to output the travel condition information including at least one of traffic conditions and road conditions, the fuel gauge, and/or the temperature sensor.

In some embodiments, the generating step 70 involves generating a physical object representation relating to a physical object in a vicinity of the mobile vehicle 12 based on physical object context information selected from the group consisting of a location of the physical object, a speed of the physical object, and a travel direction of the physical object. The context information generating devices 22 used to produce the context information of the physical object representation may include a perception device that is configured to detect at least one of the location of the physical object, the speed of the physical object, and the travel direction of the physical object. Such perception devices include one or more cameras, a radar device, a lidar device, and/or another suitable perception device. Examples of the physical objects include a motor vehicle, a pedestrian, infrastructure, and a cellular vehicle-to-everything (C-V2X) participant.

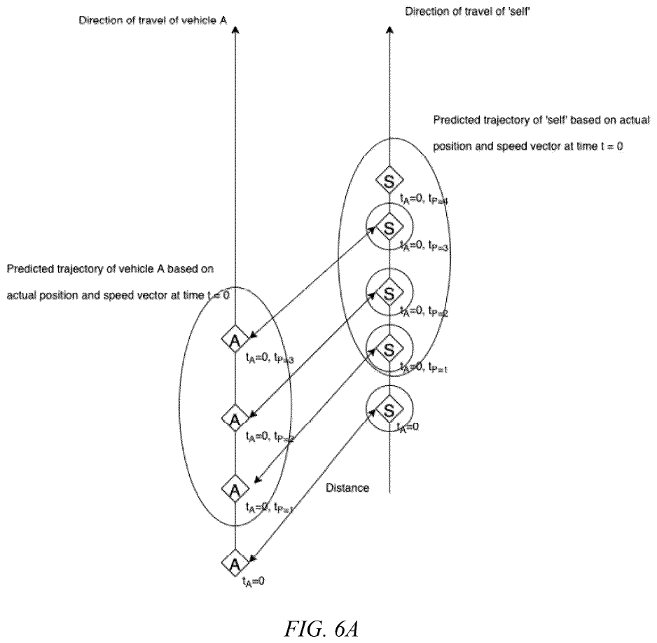

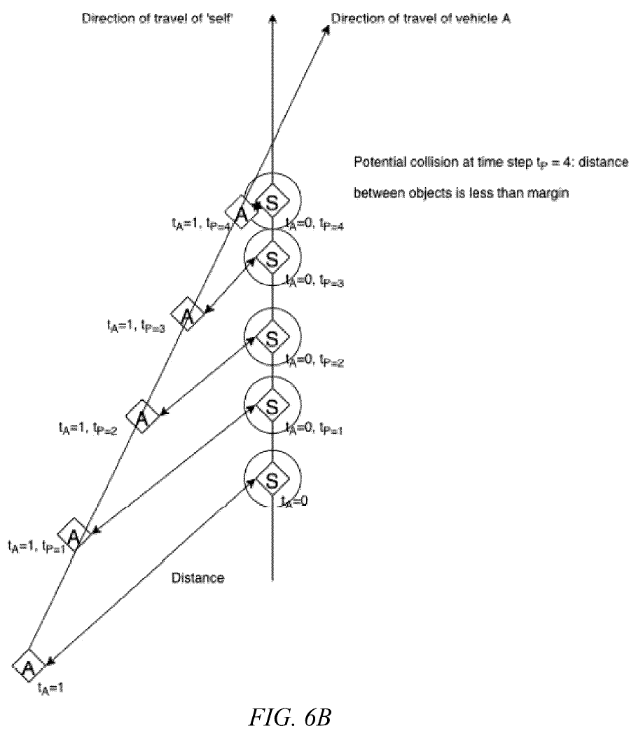

An example of collision-related events will be described with regard to FIGS. 6A and 6B, which detail how a probable collision risk may be predicted and avoided by the method. In FIGS. 6A and 6B, the mobile vehicle 12 is represented as an “S” or “self” on the drawing. In the examples, a perception device 22 of the mobile vehicle 12, such as a rear-view camera, spots a detected vehicle, which is represented as an “A” on the drawing.

The system 10 of the mobile vehicle 12 includes one or more object representations 30 generated in accordance with method step 70, including a mobile vehicle object representation for travel states of the mobile vehicle S, and a physical object representation for travel states of the detected vehicle A. The system 10 also includes event descriptors 50, including one defining a collision event type 52 having an associated severity level 54 of the event, related object types 58, one or more event detection functions 60, and/or other elements, as discussed above.

A prediction (step 72) of possible future travel states of the mobile vehicle object representation and the detected vehicle object representation are made at every time step of the situation, using the corresponding state prediction functions 38. These prediction functions may take as inputs different context information or parameters of the current ride, such as the speed and direction vector of the two vehicles, known driver behavior, weather conditions, other nearby vehicles, traffic density, previous predictions, and/or parameters values, etc., and generate multiple probable vehicle direction vectors. Each new vector is used to determine the future states of the mobile vehicle S and the detected vehicle A at given times (tp).

Each future state (step 76) is evaluated based on the event detection function for every event descriptor available, and event representations are generated if an event is found to occur in that future state. As the context evolves through time, the probability of future states (step 74) is continuously reassessed and updated to allow the system 10 to focus on the most probable future states.

When the probability of a future state occurring exceeds a corresponding threshold 40, the events 42 of that future state are acted upon by the system 10. This includes the performance of the one or more actions associated with the action items 56 of the events, as discussed above with regard to step 80 of the method.

FIGS. 6A and 6B respectfully illustrate current (actual) states of the mobile vehicle S and the detected vehicle A at times t=0 and t=1, and various predicted future states of the mobile vehicle S and the detected vehicle A at given times tₚ=1, 2, 3 and 4 from their current states. The circle surrounding vehicle S defines a tolerance region or boundary defining a distance threshold (e.g., event threshold 62) of the collision event descriptor that defines an imminent collision.

In the situation of FIG. 6A, none of the predicted future states of the vehicles S and A overlap the tolerance region or boundary of the mobile vehicle S at the future times tₚ. Therefore, none of the predicted future states trigger the collision event descriptor. Accordingly, a future collision event is not detected or predicted in the situation of FIG. 6A at the current time of t=0. As a result, the predicted future states may be eliminated from the corresponding mobile vehicle object representation and the physical object representation.

In FIG. 6B, the future states of the vehicle A does not breach the tolerance region or boundary of the vehicle S over time periods tₚ=1, 2 or 3. However, at time period tₚ=4, the vehicle A breaches the tolerance region or boundary. As a result, a potential collision event 42 is detected (step 76) stored in association with the future state 34 of the mobile vehicle object representation for the vehicle S corresponding to time period tₚ=4. The system 10 may then perform the associated actions (steps 78 and 80) designated by the action items 56 of the collision event, such as the issuance of notifications (e.g., warnings) using one of the notification devices 66, and/or the control of the mobile vehicle S, such as decelerating or accelerating the mobile vehicle S using one of the control devices 68 in response to the collision event to avoid the predicted collision.

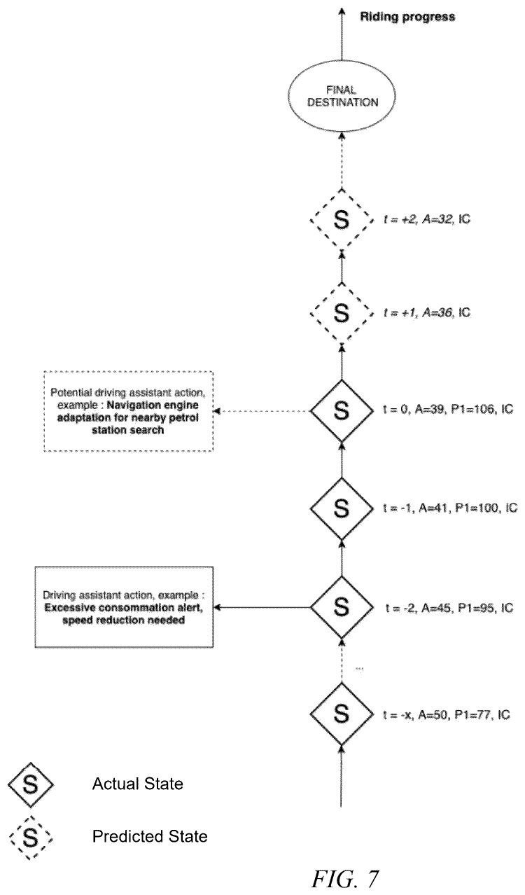

FIG. 7 illustrates an example of how a fuel object representation may be used to predict one or more fuel events, such as when a rider of the mobile vehicle 12 should be notified of a fuel related issue to reach a desired final destination. The mobile vehicle 12 is represented as an “S” on the drawing, t represents a time step, A represents autonomy, A represents predicted autonomy, and P1 . . . Px represent additional input parameters.

In one embodiment, the event descriptors 50 of the system 10 include an entry describing the event type 52 for fuel consumption including the severity 54 of the event, relevant object types 58, event detection functions 60, and associated thresholds and limits 62 that may have been set by the system manufacturer, and/or other parameters.

A prediction of future states (step 72) relating to the available range of the mobile vehicle S (phantom boxes) are made at every time step of the ride. These predictions may take as inputs different parameters of the current ride like the speed, weather conditions, current autonomy, as well as past values of the current ride, historic values of past rides, etc.

The predicted future states 34 may be provided with probability scores and an associated maximum reaction time (threshold 40) that will be used to prepare the rider to an action if necessary. At time t=−2, a future event is detected (step 76) that the range of mobile vehicle 12 is less than that required to reach the final destination. One or more actions associated with the detected event may then be performed by the system 10 (steps 78 and 80), such as by issuing a notification using one of the notification devices 66 that alerts the driver that the rate of fuel consumption is too high to reach the final destination, and/or that a speed reduction is required, for example.

At time t=0, a future event is detected (step 76) that the mobile vehicle 12 will be unable to reach the final destination due to insufficient fuel. One or more actions associated with the detected event may then be performed by the system (step 80), such as notifying the driver to navigate to a nearby petrol station, for example.

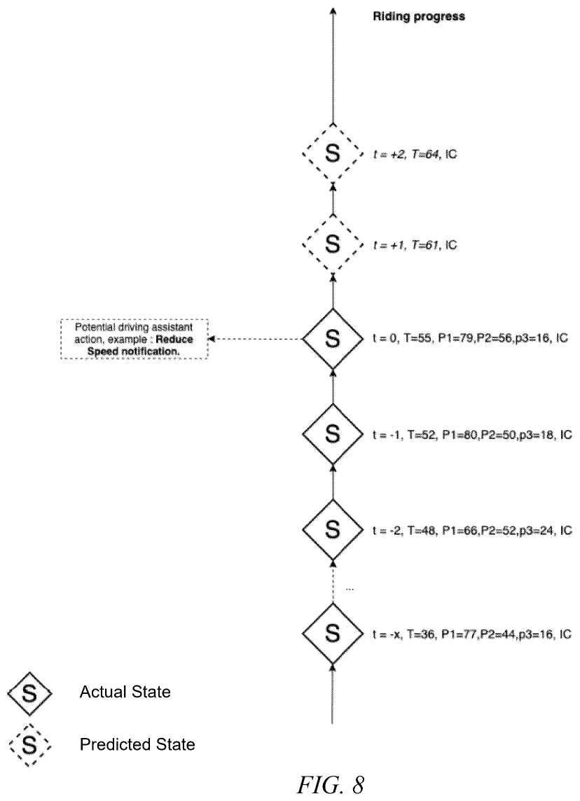

FIG. 8 illustrates an example of how an engine object representation may be used to predict one or more engine malfunction (e.g., overheating) events by the method performed by the system 10. The mobile vehicle 12 is represented as an “S” on the drawing, t represents a time step, T represents the engine temperature, T represents a predicted engine temperature, and P1 . . . Px represent additional input parameters.

In one embodiment, the event descriptors of the system 10 include an entry describing the event type 52 of engine overheating including the severity 54 of the event, the relevant object types 58, the event detection function 60, and the thresholds and limits provided in the event specific data 62, such as those fixed by the system manufacturer, and/or other parameters.

A prediction of future states (step 72) relating to the temperature of the engine of the mobile vehicle S (phantom boxes) are made at every time step of the ride. These predictions take as inputs the current engine temperature state, past engine temperature values of the ride, historic values of the engine temperature from past rides and other parameters of the current ride like the speed, weather conditions, current temperature, etc.

The following time steps will either confirm the probability of the predicted future state, or the future state will be removed if the cause of the engine overheating is removed.

Predicted future states that violate the set engine temperature threshold 62 of the engine overheating event descriptor will result in the detection of the event (step 76), and the creation of a future event representation in the predicted future state. The system 10 can then issue a notification and/or control the mobile vehicle S (step 80). For example, the rider may be notified of the threat of the engine overheating using the notification device 22.

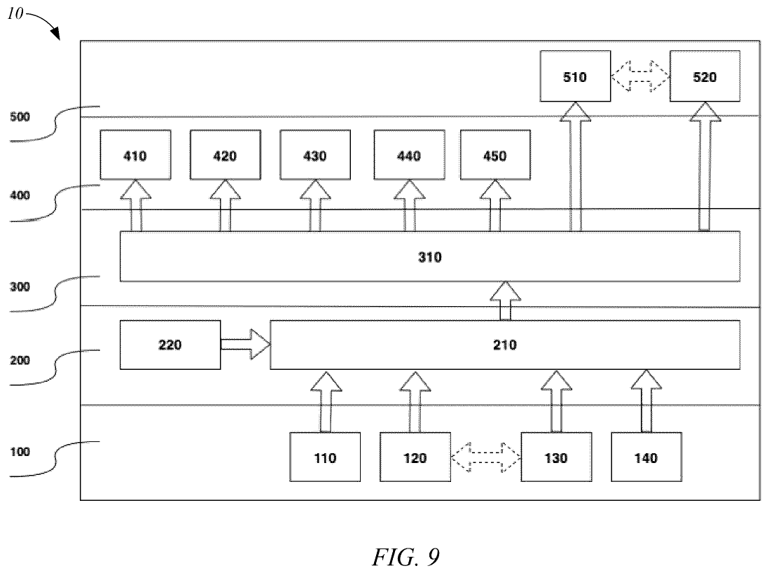

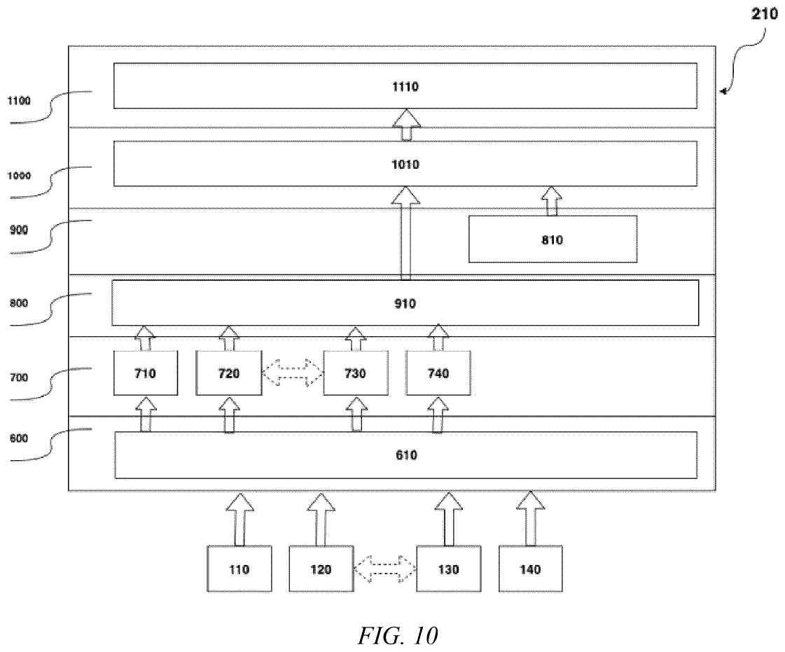

Additional embodiments relate to a computing architecture of the system 10 that is configured to perform the method in response to the execution of program instructions 18 stored in the memory 20 (FIG. 1), and will be described with reference to FIGS. 9 and 10.

FIG. 9 is a block diagram of a computing architecture of the system 10 of a mobile vehicle, such as a two-wheeled vehicle (e.g., a bike, e-bike or motorbike). The system 10 includes a control input layer 100, a computing system layer 200, a message-dispatching layer 300, a notification layer 400 and a control layer 500.

The control input layer 100 may include input or context information generating devices 110,120,130,140 (devices 22 in FIG. 1) that send digital data to the computing layer 200.

The computing system layer 200 includes a control component 210, which generates the notification and control messages of step 80 based on the data received from the control input layer 100 and the program instructions 18 stored in the computer-readable medium 220 (memory 20 in FIG. 1), and sends them to the message dispatching layer 300.

The message dispatching layer 300 sends notification messages to one or more of the available notification devices 410, 420, 430, 440, 450 (devices 66 in FIG. 1) in the notification layer 400, and sends control messages to appropriate control message receivers 510, 520 in the control layer 500 for controlling the control devices 68 (FIG. 1).

In one embodiment, the control component 210 is part of the larger system embedded on the mobile vehicle 12. It executes the program instructions 18 stored in computer-readable medium 220 or memory 20 to perform its tasks.

The mobile vehicle 12 may be equipped with or connected to (wired or wireless connections) different data-generating input or context information generating devices 110, 120, 130, 140 that connect to the control component 210. Each data-generating input device provides structured information to the control component 210 and updates to this information.

The control component 210 may send (step 80) notification messages to a plurality of available notification devices 410 . . . 450 (notification device 66) represented on the notification layer 400 through the message-dispatching module 310. Such notification devices can be connected by wire or wirelessly.

The control component 210 may send (step 80) control messages to a plurality of control devices 510, 520 (control device 68) represented on control layer 500 through the message-dispatching module 310. Such control devices can be connected by wire or wirelessly. Some of these control devices may also be data generating input or context information generating devices 22. Upon receiving a control message, such control device will execute one or more actions associated with the control message, such as applying the brake of the vehicle, accelerating the vehicle, or performing another control function. The form and extent of the control message provided may be dependent on the type of control device.

An example of such a device on the mobile vehicle includes a CAN bus. The control layer 510 can send a control message to the CAN bus with the instruction to activate the warning signal, or to activate the brakes, for example.

Another example of a control message is an instruction to the on-board audio management system to mute the audio, or an instruction to a connected mobile phone to silence an incoming call.

A further example of a control message on the mobile vehicle is an instruction to activate an emergency call (e-call) in case of an engine breakdown or accident.

As discussed above, the system 10 attempts to predict the possible occurrence of one or more events (e.g., collision event, etc.) to allow the operator of the vehicle or a component of the vehicle to make some corrective action to avoid the event. Thus, the system may, in response to a detected event, activate a warning signal or notification to the operator, control the mobile vehicle, send an emergency call (e-call) in the case of an accident or sudden health issue of the rider, and perform other actions associated with the detected event.

FIG. 10 is a simplified block diagram illustrating an example of the computing system 210, in accordance with embodiments of the present disclosure. The computing system may include a context layer 600 that generates (step 70) and maintains up to date object representations 710, 720, 730, 740 of the environment of the mobile vehicle 12 in the object layer 700. A state generation component 910 generates or predicts (step 72) probable future states for each object 710, 720, 730, 740 in layer 700 by calling their respective state prediction functions.

Each of the object representations maintains a list of its future states and evaluates the list with every update of any of its properties. Future states that can no longer, or are unlikely to become an actual state may be removed from the list. Newly possible future states may be added over time.

An event description layer 800 maintains a store 810 of event descriptors (event descriptors 50). An event generation component 1010 in layer 1000 evaluates every state of every object 710, 720, 730, 740 for the different types of events described by the event descriptors in 810 (step 76), and generates or detects the appropriate events of each future state (step 74) using the event detection function 60 of the event descriptor. Future states that are uneventful, i.e. that have no events, may be eliminated (step 74) from the list of states of the corresponding object representations.

The state probability evaluation component 1110 (state prediction functions 38) in layer 1100 evaluates for each future state in each object 710, 720, 730, 740, the probability that the state will materialize. When the probability that a future state occurs exceeds the threshold 40 as set by the generating object representation, all events associated with the future state are returned to the assistive system 10 with their actionable insights 56.

In some embodiments, the severity level 54 is returned with the corresponding actionable insights 56. In the case where thresholds of multiple future states have been exceeded, the actionable insights of all of the future states may be returned and ordered by their corresponding severity levels 54, as discussed above.

In the embodiment shown in FIG. 10, the system maintains a store of event descriptors 810 of such events that require notification and/or control action. As discussed above with reference to FIG. 4, such event descriptors 50 may include the type of event 52, the type of applicable objects 58, the severity 54 of the event, the actionable insights or action items 56 corresponding to the different notification types and/or control messages or actions associated with different control objects, etc. As an example, one such event is a collision event, such as that described with reference to FIGS. 6A and 6B. The collision event is of the collision type and is applicable to any pair of physical objects in the context.

To achieve the goal of notification and control, an exemplary embodiment of the disclosure builds (e.g., step 70), in a first step, a context 610 of the world in which the system evolves, based on the inputs of the data-generating devices and keeps the context up to date by processing the information updates provided by the data-generating devices.

In the case of the exemplary embodiment the context is composed on the one hand of object representations 30 of physical objects 710, 720 such as the mobile vehicle 12, and objects in the surroundings of the mobile vehicle 12 like other vehicles (e.g., two-wheeled vehicles, cars, trucks), pedestrians, infrastructure, etc., with their relevant properties like position, speed, direction of travel, etc.

Also, the context may include object representations of abstract notions 730, 740 like fuel consumption, weather with physical properties like temperature, wind strength and direction, rain, etc.

Each of the object representations 710, 720, 730, 740 in the context is configured to predict (step 72) a plurality of possible future states (e.g., future states 34) based on their respective state prediction functions 38. Such future state predictions can be the result of a procedural function or can be the result of evaluating an AI model trained specifically for predicting a certain property or behavior given a set of inputs that reflect the current state of the context. For example, when the mobile vehicle 12 is approaching a road section (e.g. a crossing) and a neural network based AI model, trained on an annotated database of accidents, predicts a danger level based on the number, position and speed of the cars, the weather conditions, etc., a future state at the time the mobile vehicle will enter that dangerous road section may be created.

For each future state of every object 710, 720, 730, 740, and for each event descriptor 50 in the store 810, event representations for occurring events are detected (step 76), created and stored in the future state. Future states that have no events are discarded (step 74).

State probability evaluation component 1110 (e.g., state prediction function 38) tracks the evolution of the probability of occurrence of every future state in every object. When the probability that a future state occurs exceeds the threshold as set by the generating object, all events associated with the future state are returned (78) to the assistive system 10 with their actionable insights 56. In some embodiments, a severity level 54 is also returned with the corresponding actionable insights. In the case where the thresholds of multiple states have been exceeded, the actionable insights 56 of all states are returned and ordered by their severity levels 56.

The system can then proceed with step 80 and perform the one or more actions associated with the detected event, or those associated with the detected event having the highest severity level, for example.

The system 10 and the method it performs provides advantages over conventional vehicle assistive systems.

Although the present disclosure has been described with reference to one or more examples, workers skilled in the art will recognize that changes may be made in form and detail without departing from the scope of the disclosure and/or the appended claims. Also, elements of an embodiment can be implemented in other embodiments disclosed herein either separately or in combination with other elements of the same of different embodiments.

1. A vehicle assistive system of a mobile vehicle, the system comprising:
a plurality of context information generating devices, each device configured to output context information relating to the mobile vehicle;
a processor; and
a non-transitory computer-readable medium comprising instructions stored thereon, which when executed by the processor configure the vehicle assistive system to perform acts comprising:
generating one or more object representations based on corresponding context information including a mobile vehicle object representation relating to parameters of the mobile vehicle;
predicting one or more future states for each object representation, each future state relating to a state of the object representation at a future time;
eliminating the future states of each object representation having a probability that does not meet a corresponding threshold;
detecting a future event for one or more of the future states;
providing one or more action items for each detected future event; and
performing one or more actions associated with the action items, the one or more actions including an action selected from the group consisting of generating a notification using a notification device, and controlling the mobile vehicle using a control device.

2. The system according to claim 1, wherein generating one or more object representations includes generating the mobile vehicle object representation based on mobile vehicle context information selected from the group consisting of a location of the mobile vehicle, a speed of the mobile vehicle, a direction of travel of the mobile vehicle, driver behavior information, weather condition information, travel condition information, a rate of fuel consumption, a remaining fuel capacity, a driving range of the mobile vehicle, and a temperature of the engine.

3. The system according to claim 2, wherein the context information generating devices are selected from the group consisting of:
a GPS unit providing at least one of the location, speed, and direction of the mobile vehicle;
a weather receiver configured to output the weather condition information including at least one of a temperature, wind speed, and wind direction;
a travel conditions receiver configured to output the travel condition information including at least one of traffic conditions and road conditions;
a fuel gauge; and
a temperature sensor.

4. The system according to claim 1, wherein generating the one or more object representations includes generating a physical object representation relating to a physical object in a vicinity of the mobile vehicle based on physical object context information selected from the group consisting of a location of the physical object, a speed of the physical object, and a travel direction of the physical object.

5. The system according to claim 4, wherein the context information generating devices include a perception device configured to detect at least one of the location of the physical object, the speed of the physical object, and the travel direction of the physical object.

6. (canceled)

7. The system according to claim 1, wherein:
predicting one or more future states includes predicting future travel states of the mobile vehicle object representation and the physical object representation;
detecting the future event includes detecting a future collision event between the mobile vehicle and the physical object based on the future travel states and a preset separation distance; and
performing the one or more actions comprises at least one of generating a collision notification using the notification device, and accelerating or decelerating the mobile vehicle using the control device.

8. The system according to claim 1, wherein:
predicting one or more future states includes predicting future fuel states of the mobile vehicle based on at least one of the speed of the mobile vehicle, the weather condition information, historical ride information, the rate of fuel consumption, the remaining fuel capacity, and the driving range of the mobile vehicle;
detecting the future event includes detecting a future fuel event based on the future fuel states and preset fuel-related limits; and
performing the one or more actions comprises at least one of generating a fuel notification using the notification device, and decelerating the mobile vehicle using the control device.

9. The system according to claim 1, wherein:
predicting one or more future states includes predicting engine temperature states of an engine of the mobile vehicle based on at least one of the speed of the mobile vehicle, the weather condition information, and the temperature of the engine;
detecting the future event includes detecting a future engine temperature event based on the future engine temperature states, and preset engine temperature thresholds and limits; and
performing the one or more actions comprises generating an engine temperature notification using the notification device.

10. The system according to claim 1, wherein:
the mobile vehicle includes one or more control devices selected from the group consisting of a brake for slowing the mobile vehicle and a throttle for accelerating the mobile vehicle; and
performing one or more actions comprises one of decelerating the mobile vehicle using the brake, and accelerating the mobile vehicle using the throttle.

11. (canceled)

12. The system according to claim 1, wherein:
detecting a future event for one or more of the future states comprises detecting a plurality of future events for the one or more future states;
the acts include providing a severity level for each detected future event; and
performing one or more actions associated with the action items comprises ranking the detected future events based on their corresponding severity levels, and performing one or more actions corresponding to the one or more action items of the detected future event having the highest severity level.

13. A two-wheeled mobile vehicle comprising the system according to claim 1, wherein the two-wheeled mobile vehicle is selected from the group consisting of a motorcycle and an E-bike.

14. A method performed by a vehicle assistive system of a mobile vehicle, the method comprising:
receiving context information relating to travel of the mobile vehicle from a plurality of context information generating devices;
generating one or more object representations based on corresponding context information including a mobile vehicle object representation relating to parameters of the mobile vehicle;
predicting one or more future states for each object representation, each future state relating to a state of the object representation at a future time;
eliminating the future states of each object representation having a probability that does not meet a corresponding threshold;
detecting a future event for one or more of the future states;
providing one or more action items for each detected future event; and
performing one or more actions associated with the action items, the one or more actions including an action selected from the group consisting of generating a notification using a notification device, and controlling the mobile vehicle using a control device.

15. The method according to claim 14, wherein generating one or more object representations includes generating the mobile vehicle object representation based on mobile vehicle context information selected from the group consisting of a location of the mobile vehicle, a speed of the mobile vehicle, a direction of travel of the mobile vehicle, driver behavior information, weather condition information, travel condition information, a rate of fuel consumption, a remaining fuel capacity, a driving range of the mobile vehicle, and a temperature of the engine.

16. The method according to claim 15, wherein the context information generating devices are selected from the group consisting of:
a GPS unit providing at least one of the location, speed, and direction of the mobile vehicle;
a weather receiver configured to output the weather condition information including at least one of a temperature, wind speed, and wind direction;
a travel conditions receiver configured to output the travel condition information including at least one of traffic conditions and road conditions;
a fuel gauge; and
a temperature sensor.

17. The method according to claim 14, wherein generating the one or more object representations includes generating the physical object representation relating to a physical object in the vicinity of the mobile vehicle based on physical object context information selected from the group consisting of a location of the physical object, a speed of the physical object, and a travel direction of the physical object.

18. (canceled)

19. The method according to claim 14, wherein:
predicting one or more future states includes predicting future travel states of the mobile vehicle object representation and the physical object representation;
detecting the future event includes detecting a future collision event between the mobile vehicle and the physical object based on the future travel states and a preset separation distance; and
performing the one or more actions comprises at least one of generating a collision notification using the notification device, and accelerating or decelerating the mobile vehicle using the control device.

20. The method according to claim 14, wherein:
predicting one or more future states includes predicting future fuel states of the mobile vehicle based on at least one of the speed of the mobile vehicle, the weather condition information, historical ride information, the rate of fuel consumption, the remaining fuel capacity, and the driving range of the mobile vehicle;
detecting the future event includes detecting a future fuel event based on the future fuel states and preset fuel-related limits; and
performing the one or more actions comprises at least one of generating a fuel notification using the notification device, and decelerating the mobile vehicle using the control device.

21. The method according to claim 14, wherein:
predicting one or more future states includes predicting engine temperature states of an engine of the mobile vehicle based on at least one of the speed of the mobile vehicle, the weather condition information, and the temperature of the engine;
detecting the future event includes detecting a future engine temperature event based on the future engine temperature states, and preset engine temperature thresholds and limits; and
performing the one or more actions comprises generating an engine temperature notification using the notification device.

22. The method according to claim 14, wherein:
the mobile vehicle includes one or more control devices selected from the group consisting of a brake for slowing the mobile vehicle and a throttle for accelerating the mobile vehicle;
the mobile vehicle includes one or more notification devices selected from the group consisting of a display screen, a head-up display, a sound device, a haptic device, and indicating lights; and
performing one or more actions comprises one of decelerating the mobile vehicle using the brake, accelerating the mobile vehicle using the throttle, and generating a notification using one or more of the notification devices.

23. The method according to claim 14, wherein:
detecting a future event for one or more of the future states comprises detecting a plurality of future events for the one or more future states;
the acts include providing a severity level for each detected future event; and
performing one or more actions associated with the action items comprises ranking the detected future events based on their corresponding severity levels, and performing one or more actions corresponding to the one or more action items of the detected future event having the highest severity level.
